(19) United States
(12) Patent Application Publication
(10) Pub. No.: US 2018/0010004 A1
(43) Pub. Date: Jan. 11, 2018

(54) COLORLESS RADIATION CURABLE BINDER DISPERSION

(71) Applicant: Hewlett-Packard Development Company, L.P., Houston, TX (US)

(72) Inventors: Tienteh Chen, San Diego, CA (US); Bin Huang, San Diego, CA (US); George Sarkisian, San Diego, CA (US); Fereshteh Khorrami, San Diego, CA (US); Phuong My Pham, San Diego, CA (US)

(21) Appl. No.: 15/544,489

(22) PCT Filed: Jan. 30, 2015
(86) PCT No.: PCT/US2015/013694

§ 371 Date: Jul. 18, 2017

(51) Int. Cl. C09D 11/30; C08L 75/16; C09D 11/101; C09D 11/54

(52) U.S. Cl. CPC C09D 11/30; C09D 11/54; C08L 75/16; C09D 11/101; C08L 2201/54

(57) ABSTRACT

A colorless radiation curable binder dispersion includes water and a radiation curable polyurethane. The polyurethane is formed from a polyisocyanate; an acrylate or methacrylate having at least two hydroxyl (OH) groups and an acrylate or methacrylate group; another acrylate or methacrylate having an OH or amino group; and one of: i) a sulfonate or sulfonic acid having one amino group; ii) a combination of i and a compound including a carboxylic group and an OH or amino group; iii) a combination of i and a homopolymer or copolymer of poly(ethylene glycol) having one or two OH or amino groups at one chain end; or iv) a combination of i, a compound including a carboxylic group and an OH or amino group, and a homopolymer or copolymer of poly(ethylene glycol) having one or two OH or amino groups at one chain end.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. This technology has become a popular way of recording images on various media surfaces (e.g., paper), for a number of reasons, including, low printer noise, capability of high-speed recording and multi-color recording.

### DETAILED DESCRIPTION

In inkjet printing, polyurethane dispersions may be added to inkjet inks to improve the durability of the resulting print. In particular, radiation curable polyurethanes have been added to improve the scratch and abrasion resistance of the resulting prints. However, it has been found that the amount and type of polyurethane used in the inkjet inks may lead to complications with the jetting performance and reliability (e.g., nozzle health).

These complications may include poor decap performance of the ink (which includes the polyurethane). The term “decap performance,” as referred to herein, means the ability of the inkjet ink to readily eject from the printhead, upon prolonged exposure to air. The decap time is measured as the amount of time that a printhead may be left uncapped (i.e., exposed to air) before the printer nozzles no longer fire properly, potentially because of clogging, plugging, or retraction of the colorant from the drop forming region of the nozzle/firing chamber. The length of time a thermal inkjet pen can remain unused and uncapped before spitting would be required to form an acceptable quality ink drop is called decap time, or first drop decap time. Another decap metric is the number of spits required to get the pen healthy at a specific time interval. A decreased decap time can lead to poor print reliability. As such, the longest decap time that would give acceptable first drop quality or the fewest number of spits required at any given decap time would be desirable for any given ink.

Examples of the inkjet ink disclosed herein, which include the colorless radiation curable polyurethane binder dispersion disclosed herein, exhibit several desirable characteristics, one of which is improved decap performance. In particular, when the inkjet ink is printed at intervals with idle and uncapped periods between printing intervals, the number of spits (drops) required to obtain a healthy (i.e., drop weight and location) normal drop on a medium is reduced, e.g., when compared to inks including other types of polyurethane dispersions.

The improved decap performance may be due, at least in part, to the particular sulfonate or sulfonic acid, which has one amino functional group, that is used to form the polyurethane binder. The particular sulfonate or sulfonic acid is not a chain extender, and may be attached to the chain end of the polyurethane.

The improved decap performance may also be due to the relatively small size of the polyurethane binder. For example, the polyurethane binder may be in the form of particles having an average diameter ranging from about 10 nm to about 200 nm. These small particles can be easily jetted, and thus do not deleteriously affect the nozzle health.

Other properties of the colorless radiation curable polyurethane binder dispersion include the double bond density (i.e., milliequivalents (10⁻³ equivalent) of double bonds per 1 gram of dry polymer) and the acid number (e.g., the sum of both weak and strong acid groups, with a unit of mg KOH per 1 gram of polymer). These properties may contribute to the inkjet ink having dispersion stability, faster curing speed, and the ability to form durable prints. Overall, the inkjet inks including examples of the colorless radiation curable polyurethane binder dispersion disclosed herein exhibit improved jetting performance and print reliability.

Improved decap performance results in the application of an acceptable quality ink drop. As such, the inkjet ink compositions that include the colorless radiation curable polyurethane dispersion have improved image quality when compared to inks including other types of polyurethane dispersions (e.g., those that do not include the sulfonate or sulfonic acid). Additionally, the improved image quality (e.g., optical density and gloss) may also be due, at least in part, to the particular homopolymer or copolymer of poly(ethylene glycol) that may be used to form the colorless radiation curable polyurethane dispersion. Still further, improved image quality results when the inkjet ink is coupled with a pre-treatment fixer fluid.

The radiation curable inkjet ink, which includes the colorless radiation curable polyurethane binder disclosed herein, may be included in a single cartridge ink set or a multiple-cartridge ink set (which may or may not include the pre-treatment fixer fluid). In the multiple-cartridge ink set, any number of the multiple inks may have the colorless radiation curable polyurethane binder incorporated therein. As used herein, the terms “ink(s)” and “ink composition” refer to the radiation curable, inkjet ink.

In an example, the inkjet ink disclosed herein includes a co-solvent (in addition to any water that is present), a colorant, a photoinitiator, the colorless radiation curable polyurethane binder, and a balance of water (which is the main solvent). In some examples, the inkjet ink composition consists of these components, with no other components. As one example, the inkjet ink may exclude polymers other than the colorless radiation curable polyurethane binder disclosed herein. In other examples, the inkjet ink composition may include other components, such as a surfactant and an anti-kogation agent.

As used herein, “ink vehicle” may refer to the liquid fluid in which the colorless radiation curable polyurethane binder (e.g., the colorless radiation curable polyurethane binder dispersion) and the colorant (e.g., a colorant dispersion) are placed to form the ink(s). A wide variety of ink vehicles may be used in the inkjet ink. The ink vehicle may include water alone or in combination with a mixture of a variety of additional components. Examples of these additional components may include the co-solvent(s), the surfactant(s), the anti-kogation agent(s), and/or photoinitiator(s).

The co-solvent(s) may be present in the inkjet ink in an amount ranging from about 0.1 wt % to about 30 wt %, depending, at least in part, on the jetting architecture to be used. In an example, the co-solvent is present in the inkjet ink in an amount of about 10 wt % based on the total wt % of the inkjet ink. It is to be understood that other amounts outside of this example and range may also be used. Classes of co-solvents that may be used include organic co-solvents, such as aliphatic alcohols, aromatic alcohols, diols, glycol ethers, polyglycol ethers, 2-pyrrolidinones, caprolactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. In some examples, the ink vehicle may include 1-(2-hydroxyethyl)-2-pyrrolidone.

The inkjet ink may also include a photoinitiator. The photoinitiator initiates the polymerization and/or crosslinking of the colorless radiation curable polyurethane upon exposure to a suitable stimulus (e.g., electromagnetic radiation). Some examples of the photoinitiator include 1-[4-(2-Hydroxyethoxy)-phenyl]-2-hydroxy-2-methyl-1-propane-1-one (which is commercially available from BASF Corp. as IRGACURE® 2959); acyl phosphine oxide photoinitiators (e.g., IRGACURE® 819, commercially available from BASF Corp.); alpha hydroxy ketone photoinitiators (e.g., IRGACURE® 184, commercially available from BASF Corp.); Iodonium, (4-methylphenyl)[4-(2-methylpropyl) phenyl]-, hexafluorophosphate(1-) (which is commercially available from BASF Corp. as IRGACURE® 250); a high-molecular-weight sulfonium salt (e.g., IRGACURE® 270, commercially available from BASF Corp.); 2-Benzyl-2-dimethylamino-1-(4-morpholinophenyl)-butanone-1 (which is commercially available from BASF Corp. as IRGACURE® 369); alpha amino ketone photoinitiator (e.g., IRGACURE® 379, commercially available from BASF Corp.); a liquid blend of alpha hydroxy ketone/benzophenone photoinitiator (e.g., IRGACURE® 500, commercially available from BASF Corp.); and a liquid photoinitiator blend of acyl phosphine oxide/alpha hydroxy ketone (e.g., IRGACURE® 2022, commercially available from BASF Corp.). Some other suitable photoinitiators include phosphine oxide derivatives, thioxanthone derivatives, and benzophenone derivatives. The photoinitiator is present in the inkjet ink in an amount ranging from about 0.1 wt % to about 1.0 wt % of the total wt % of the ink. In another example, the photoinitaitor is present in the in the inkjet ink in an amount ranging from about 0.2 wt % to about 0.6 wt. % of the total wt % of the ink.

As mentioned above, the ink vehicle of the inkjet ink may also include surfactant(s). As an example, the inkjet ink may include non-ionic, cationic, and/or anionic surfactants, which may be present in an amount ranging from about 0.01 wt % to about 5 wt % based on the total wt % of the inkjet ink. In at least some examples, the ink vehicle may include a silicone-free alkoxylated alcohol surfactant such as, for example, TECO® Wet 510 (Evonik Tego Chemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylated acetylenic diol), SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.).

The ink vehicle of the inkjet ink may include the anti-kogation agent. Kogation refers to the deposit of dried ink on a heating element of a thermal inkjet printhead. Anti-kogation agent(s) is/are included to assist in preventing the buildup of kogation. Examples of suitable anti-kogation agents include oleth-3-phosphate (commercially available as CRODAFOS® O3A or CRODAFOS® N-3 acid from Croda Int.) or dextran 500k. Other suitable examples of the anti-kogation agents include CRODAFOS® HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. The anti-kogation agent may be present in the inkjet ink in an amount ranging from about 0.05 wt % to about 2 wt % of the total wt % of the ink.

In some examples disclosed herein, the ink vehicle of the inkjet ink may also include antimicrobial agent(s) (biocide(s)), viscosity modifier(s), material(s) for pH adjustment, sequestering agent(s), preservative(s), jettability additive(s) (e.g., liponic ethylene glycol (LEG-1), available from Liponics), and the like.

When a biocide is utilized, a suitable amount of the biocide may range from about 0.05 wt % to about 0.5 wt % of a total wt % of the ink. In examples, the biocide is present at about 0.18 wt %, or at about 0.14 wt % of a total wt % of the ink. It is to be understood that the upper limit for the biocide(s) may depend upon the type of biocide and its toxicological effect and/or regulatory requirements. For example, the upper limit for PROXEL® GXL (Arch Chemicals, Inc., Norwalk, Conn.) is 0.2 wt %. Suitable biocides include, for example, PROXEL® GXL, KORDEK® MLX (The Dow Chemical Co.), and/or BIOBAN® CS-1246 (The Dow Chemical Co.).

The inkjet ink may be any color, such as black, cyan, magenta, yellow, etc. As such, in addition to the ink vehicle, the inkjet ink also includes a colorant. In an example, the colorant is a self-dispersed pigment added to the ink vehicle. In another example, the colorant is a pigment in a dispersion including water, the pigment, and a polymer that disperses the pigment (i.e., the polymer dispersant). In an example, the pigment dispersion may also include, for example, a co-solvent, such as 2-pyrrolidone. The pigment dispersion may be prepared or purchased, and the other components of the ink (e.g., vehicle components and the radiation curable polyurethane binder dispersion) may be slowly added to the pigment dispersion with continuous mixing, to form the inkjet ink.

As used herein, “pigment” may generally include organic or inorganic pigment colorants, magnetic particles, aluminas, silicas, and/or other ceramics, organo-metallics, metallic particulates, or other opaque particles that introduce color to the ink vehicle. The pigment may be any color, including, as examples, a cyan pigment, a magenta pigment, a yellow pigment, a black pigment, a violet pigment, a green pigment, a brown pigment, an orange pigment, a purple pigment, a white pigment, a metallic pigment (e.g., a gold pigment, a bronze pigment, a silver pigment, or a bronze pigment), a pearlescent pigment, or combinations thereof. Any suitable pigment may be used, and while several examples are provided herein, it is to be understood that the list is non-limiting.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, C.I. Pigment Yellow 180, and C.I. Pigment Yellow 185.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Georgia, (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Massachusetts, (such as, e.g., REGAL® 400R, REGAL® 330R, REGAL® 660R, MOGUL® E, MOGUL® L, AND ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

A suitable metallic pigment includes a metal chosen from gold, silver, platinum, nickel, chromium, tin, zinc, indium, titanium, copper, aluminum, and alloys of any of these metals. These metals may be used alone or in combination with two or more metals or metal alloys. Some examples of metallic pigments include STANDART® RO100, STANDART® RO200, and DORADO® gold-bronze pigments (available from Eckart Effect Pigments, Wesel, Germany).

The total amount of pigment in the inkjet ink ranges from about 1 wt % to about 5 wt % (based on the total wt % of the inkjet ink). The average particle size of the pigments may range anywhere from about 50 nm to about 200 nm. In an example, the average particle size ranges from about 80 nm to about 150 nm.

In the examples disclosed herein, the pigment may be dispersed by an anionic polymer (i.e., anionic polymeric dispersant). The dispersant may be present in an amount ranging from about 0.1 wt % to about 5 wt % of a total wt % of the ink composition.

In an example, the dispersant may be styrene-acrylic-type dispersants such as acrylic dispersants having i) hydrophilic monomers including acidic monomers, and ii) hydrophobic monomers. The acid number of the dispersant may range from about 120 mg/g to about 300 mg/g. It is to be understood that the styrene-acrylic-type dispersants are water soluble.

Acidic monomers that may be used in the acrylic dispersant may include, for example, acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, and combinations thereof.

Examples of the hydrophobic monomers that can be polymerized in the acrylic dispersant may include styrene, p-methyl styrene, methyl methacrylate, hexyl acrylate, hexyl methacrylate, butyl acrylate, butyl methacrylate, ethyl acrylate, ethyl methacrylate, propyl acrylate, propyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, ethoxylated nonyl phenol methacrylate, isobornyl methacrylate, cyclohexyl methacrylate, t-butyl methacrylate, n-octyl methacrylate, lauryl methacrylate, trydecyl methacrylate, alkoxylated tetrahydrofurfuryl acrylate, isodecyl acrylate, isobornylmethacrylate, and combinations thereof.

In addition to the colorant and other components, the inkjet ink also includes the colorless radiation curable polyurethane binder. By “colorless”, it is meant that the radiation curable polyurethane binder (dispersion) itself does not include (i.e., excludes) any colorant (i.e., pigment, dye, reactive, etc.), and thus there is no colorant bound (covalently or otherwise) to the polyurethane binder in the radiation curable polyurethane binder dispersion.

In an example, the colorless radiation curable polyurethane binder is present in the colorless radiation curable polyurethane binder dispersion with water. The colorless radiation curable polyurethane/radiation curable polyurethane binder is present in the ink an amount ranging from about 2.5 wt % to about 20 wt % based upon the total wt % of the inkjet ink. In another example, the amount of colorless radiation curable polyurethane/radiation curable polyurethane binder ranges from about 5 wt % to about 10 wt % or from about 5 wt % to about 15 wt % based upon the total wt % of the inkjet ink. This weight percentage accounts for the weight percent of active colorless polyurethane/polyurethane binder present in the ink composition, and does not account for the total weight percent of the colorless radiation curable polyurethane binder dispersion in the inkjet ink. As such, the weight percentages given for the colorless radiation curable polyurethane/radiation curable polyurethane binder do not account for any other components (e.g., water) that may be present when the polyurethane is part of the dispersion.

The colorless radiation curable polyurethane binder dispersion may be added with the colorant (e.g., colorant dispersion) and the components of the ink vehicle to form the inkjet ink.

The colorless radiation curable polyurethane binder dispersion may be formed by synthesizing a polyurethane solution (i.e., the polyurethane polymer in an organic solvent), and then ionizing and dispersing the polyurethane solution in water to form the colorless radiation curable polyurethane binder dispersion. The resulting colorless radiation curable polyurethane binder dispersion includes the polyurethane polymer, which is water soluble/dispersible. Each of these steps will be discussed further below.

The colorless radiation curable polyurethane binder is formed from the following components: (a) a polyisocyanate; in some instances (b) a polyol having at least two hydroxyl functional groups; (c) an acrylate or methacrylate with at least two hydroxyl functional groups and having an acrylate functional group or a methacrylate functional group; in some instances (d) a compound including a carboxylic functional group and a hydroxyl functional group or an amino functional group; (e) another acrylate or methacrylate, the other acrylate or methacrylate having a hydroxyl functional group or an amino functional group; in some instances (f) a homopolymer or copolymer of poly(ethylene glycol) having one or two hydroxyl functional groups or one or two amino functional groups at one end of its chain; and (g) a sulfonate or sulfonic acid having one or two amino functional groups. It is to be understood that since component (c) and/or component (d) include hydroxyl groups, these component(s) may participate in the formation of the urethane linkage, and thus component (b) may not be used in some examples.

In the examples disclosed herein, the polyurethane may be formed form components (a), (c), (e), and any of i) component (g), ii) a combination of components (d) and (g), iii) a combination of components (f) and (g), or iv) a combination of components (d), (f) and (g). Component (b) may also be used in any of the previously listed examples.

The components are selected so that the resulting colorless radiation curable polyurethane binder has a double bond density ranging from about 1.0 meq/g to about 6.0 meq/g, and an acid number ranging from about 10 mg/g to about 50 mg/g. The combination of these particular components and properties may improve the decap performance and print reliability of the inkjet ink.

For component (a), any suitable polyisocyanate may be used. For example, a polyisocyanate having an average of two or more isocyanate groups may be used. In an example, the polyisocyanate may be an aliphatic, cycloaliphatic, araliphatic, or aromatic polyisocyanate, as well as products of their oligomers, used alone or in mixtures of two or more. In an example, the polyisocyanate is an aliphatic polyisocyanate or a cycloaliphtic polyisocyanate, either of which has a reduced tendency to yellow. Some examples include hexamethylene-1,6-diisocyanate (HDI), 2,2,4-trimethyl-hexamethylene-diisocyanate (TDMI), 1,12-dodecane diisocyanate, 2,4,4-trimethyl-hexamethylene diisocyanate, 2-methyl-1,5-pentamethylene diisocyanate, isophorone diisocyanate (IPDI), and combinations thereof. The amount of the polyisocyanate within the colorless radiation curable binder dispersion ranges from about 20 wt % to about 50 wt % of the total wt % of the colorless radiation curable polyurethane. In an example, polyisocyanate makes up from about 30 wt % to about 50 wt % of the colorless polyurethane binder.

Turning to component (b), the amount of component (b) (i.e., the polyol) within the colorless radiation curable polyurethane binder dispersion ranges from 0 wt % to about 30 wt % of the total wt % of the colorless radiation curable polyurethane. In examples, component (b) (i.e., the polyol) makes up from about 5 wt % to about 30 wt % or from about 10 wt % to about 20 wt % of the colorless polyurethane binder.

Component (b) is a polyol. The term “polyol”, as used herein, means any polymer having 2 or more hydroxyl groups, where the hydroxyl groups are located at each end of the polymer. Some examples of suitable polyols for component (b) may be part of a first class of polyols. As examples, the first class of polyols has a number average molecular weight ranging from greater than 500 to about 6,000, or in some instances, to about 5,000. In any of these examples, component (b) is a macro-glycol. Examples of suitable polyols of the first class include polyester polyols, polyether polyols, polycarbonate polyols, poly(ethyleneoxide) polyols, polyhydroxy polyester amides, polysiloxane polyols, or mixtures thereof. In an example, the polyol is a polyether polyol, a polycarbonate polyol, or a polyester polyol.

Other examples of suitable polyols for component (b) may be part of a second class of polyols. The second class has a number average molecular weight that is 500 or lower (e.g., from about 50 to 500). Examples of suitable polyols of the second class include 1,4-butanediol, 1,5-pentanediol, 3-methylpentane-1,5-diol, 1,6-hexanediol, neopentylglycol, cyclohexane-1,4-dimethanol, trimethylolpropane, glycerol, pentaerythritol, or mixtures thereof. Other examples of suitable polyols of the second class include 1,2-propanediol, 1,3-propanediol, 1,2-butanediol, 1,3-butanediol, 1,2-cyclohexanediol, 1,4-cyclohexanediol, 2-ethyl-3-propylpentanediol, 2,4-dimethylpentanediol, 2-ethyl-2-butylpropanediol, diethyleneglycol, triethyleneglycol, tetraethyleneglycol, dipropyleneglycol, tripropyleneglycol, and N-substituted ethanolamines.

It is to be understood that a combination of any of the listed polyols may be used.

The colorless radiation curable polyurethane binder dispersion further includes component (c). Component (c) includes an acrylate or methacrylate with at least two hydroxyl functional groups and an acrylate functional group or a methacrylate functional group. In this example, component (c) is present in an amount ranging from 10 wt % to about 40 wt % based on the total wt % of the colorless radiation curable polyurethane. In another example, component (c) may be present in an amount ranging from about 20 wt % to about 40 wt % based on the total wt % of the radiation curable polyurethane.

Component (c) renders the polyurethane curable via ultraviolet light or some other suitable electromagnetic radiation. In addition, component (c) increases the double bond density and improves the curing efficiency.

Some examples of the acrylate or methacrylate with at least two hydroxyl functional groups include those obtained from the reaction of diglycidyl compounds with (meth)acrylic acid. Aliphatic diglycidyl compounds derived from alpha, omega diols having 4 to 12 carbon atoms or from polyoxyalkylenediols (such as polyethylene glycol, polypropylene glycol, or mixtures thereof that contain oxyalkylene groups) may be used. Some specific examples include 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, hydrogenated bisphenol A diglycidyl ether (BGDA or BADGE), hydrogenated bisphenol F diglycidyl ether, and their ethoxylated and/or propoxylated equivalents. An additional example is 1,6-hexanediylbis[oxy(2-hydroxy-3,1-propanediyl)] bisacrylate. Some commercially available examples include MIRAMER® PE-210 (bisphenol A epoxy acrylate) and MIRAMER® PE-230 (aliphatic alkyl epoxy acrylate) (both are available from Miwon Chemical).

In further examples, component (c) includes aromatic diglycidyl compounds derived from bisphenol A and bisphenol F. Specifically, bisphenol A diglycidyl ether, bisphenol F diglycidyl ether, and their ethoxylated and/or propoxylated equivalents may be used. Diglycidyl esters may also be used, such as diglycidyl phthalate, N,N-diglycidyl aniline, or N,N-diglycidyl-4-glycidyloxyaniline. Some specific examples include a diacrylate ester of bisphenol A diglycidyl ether (BGDA) and a dimethacrylate ester of bisphenol A diglycidyl ether (BGDM).

Component (d) is a compound including a carboxylic functional group and a hydroxyl group or an amino functional group. Component (d) is a low molecular weight compound having a number average molecular weight ranging from about 100 to about 400. The amount of component (d) within the colorless radiation curable binder dispersion ranges from greater than 0 wt % to about 10 wt % based upon the total wt % of the colorless radiation curable polyurethane. In an example, component (d) makes up from about 2 wt % to about 8 wt % of the polyurethane binder.

The presence of component (d) assists in the ability of the polyurethane to be dissolved or dispersed in water after ionization with a base. As noted above, component (d) includes the carboxylic functional group as well as a hydroxyl group or an amino group. Examples of component (d) may be derived from hydroxy-carboxylic acids having the general formula (HO)ₓQ(COOH)_{y}, where Q is a straight or branched hydrocarbon radical containing 1 to 12 carbon atoms, and x is 1 or 2 or 3 and y ranges from 1 to 3. Examples of suitable hydroxy-carboxylic acids include dimethylol propionic acid (DMPA), dimethylol butanoic acid (DMBA), alanine, citric acid, tartaric acid, glycolic acid, lactic acid, malic acid, dihydroxymaleic acid, dihydroxytartaric acid, or mixtures thereof.

Turning now to component (e), component (e) is an acrylate or methacrylate having a hydroxyl functional group or an amino functional group. Similar to component (c), component (e) also renders the polyurethane curable via ultraviolet light or some other suitable electromagnetic radiation.

The amount of component (e) in the colorless radiation curable polyurethane binder dispersion ranges from greater than 10 wt % to about 65 wt % based upon the total wt % of the colorless radiation curable polyurethane. In an example, component (e) makes up from about 20 wt % to about 50 wt % of the polyurethane binder. Within the final polyurethane, component (e) forms an end acrylate.

Some examples of component (e) include the esterification products of aliphatic and/or aromatic polyols with acrylic acid or methacrylic acid. These products have a residual OH functionality of about 1. Some of these products also have at least two acrylic functionalities. Examples of component (e) include the partial esterification products of acrylic acid and/or methacrylic acid with tri-, tetra-, penta- or hexahydric polyols or mixtures thereof. These modified or unmodified polyols are partly esterified with acrylic acid, methacrylic acid or mixtures thereof until the desired residual hydroxyl functionality is reached. Suitable examples include acrylic or the methacrylic esters with linear and branched polyols in which the at least one hydroxyl functionality remains free, such as hydroxyalkylacrylates or hydroxyalkylmethacrylates having 1 to 20 carbon atoms in the alkyl group. Some specific examples include hydroxyethylacrylate (HEA), hydroxyethylmethacrylate (HEMA), hydroxyethylacrylamide (HEAA), hydroxybutylacrylate (HBA), hydroxybutylmethacrylate (HBMA), (3-(acryloxy)-2-hydroxypropyl methacrylate) (AHPMA), glycerol diacrylate, trimethylolpropane diacrylate, pentaerythritoltriacrylate (PETA), ditrimethylolpropane triacrylate (DTPTA), dipentaerythritol pentaacrylate (DPPA), and (poly)ethoxylated and/or (poly)propoxylated equivalents of glycerol diacrylate, trimethylolpropane diacrylate, PETA, DTPTA, or DPPA.

With respect to component (f), component (f) is a homopolymer or copolymer of poly(ethylene glycol) (i.e., poly(ethylene oxide) having one or two hydroxyl functional groups or one or two amino functional groups. In some examples, the two hydroxyl or amino functional groups are positioned at one end of the poly(ethylene glycol) backbone chain. The homopolymer or copolymer of poly(ethylene glycol) has a number average molecular weight (Mₙ) ranging from about 500 to about 5,000. In another example, the homopolymer or copolymer of poly(ethylene glycol) has a number average molecular weight (Mₙ) ranging from about 500 to about 3,000. Component (f) also has a water solubility of greater than 30% v/v (volume of poly(ethylene glycol) to volume of water).

Examples of the colorless radiation curable polyurethane dispersion disclosed herein including component (f) increase the gloss and optical density of a printed image on media when compared to the gloss and optical density of a printed image on the same media formed with an ink that includes other types of polyurethane dispersions that do not include component (f). This may be due, in part, because, because component (f) prevents the polyurethane binder from reacting with an underlying pre-treatment fixing fluid, which would otherwise cause the polyurethane binder to undesirably coagulate when the ink composition is applied to the medium. As such, component (f) renders the polyurethane binder insensitive to the pre-treatment fixing fluid, and thus prevents undesirable polyurethane coagulation. Since the polyurethane binder does not strongly interact with the pre-treatment fixing fluid to cause coagulation, the polyurethane can form a film when printed, which advantageously affects the gloss and optical density of the printed image.

The amount of component (f) in the colorless radiation curable polyurethane binder dispersion ranges from 0 wt % to about 20 wt % based upon the total wt % of the colorless radiation curable polyurethane. In an example, component (f) is from about 5 wt % to about 15 wt % of the polyurethane binder.

Any copolymer of poly(ethylene glycol) with one or two hydroxyl or amino groups may be used as component (f), as long as the copolymer has water solubility of >30% v/v and a suitable number average molecular weight. Some examples of suitable copolymers for component (f) include a copolymer of poly(ethylene) and poly(ethylene glycol) with one hydroxyl functional group (e.g.,

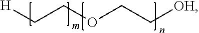

where m=1-10 and n=5-50, a copolymer of poly(propylene glycol) and poly(ethylene glycol) with one hydroxyl functional group, and a copolymer of poly(ethylene glycol) and poly(propylene glycol) with one amino functional group. Some commercially available examples of the copolymer of poly(ethylene glycol) and poly(propylene glycol) with one amino functional group include JEFFAMINE® M-1000 (i.e.,

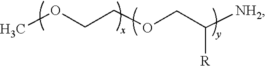

where x=19 and y=3) and JEFFAMINE® M-2070 (i.e.,

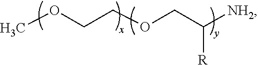

where x=31 and y=10) (both produced by Huntsman Chemicals).

Some additional examples of component (f) include a poly(ethylene glycol) homopolymer, such as monoamine terminated poly(ethylene glycol) (i.e.,

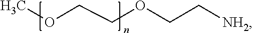

where n=5-100) and a poly(ethylene glycol) mono alkyl ether. Examples of the poly(ethylene glycol) mono alkyl ether include an alkyl group with C1 to C8 straight or branched hydrocarbons, such as methyl, ethyl, and butyl groups. Examples of the poly(ethylene glycol) mono alkyl ether include poly(ethylene glycol) monomethyl ether (i.e.,

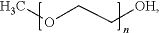

where n=5-100), poly(ethylene glycol) monoethyl ether, poly(ethylene glycol) monopropyl ether, and poly(ethylene glycol) monobutyl ether.

Furthermore, any homopolymer of poly(ethylene glycol) with two hydroxyl or amino groups at one end of the polymer chain may alternatively be used as component (f), as long as the homopolymer has water solubility of >30% v/v and a suitable number average molecular weight. As an example, the homopolymer may be two hydroxyl terminated poly(ethylene glycol), where both hydroxyls are at one end of the chain. An example of a commercially available two hydroxyl terminated poly(ethylene glycol) is YMER™ N120 (a linear difunctional polyethylene glycol monomethyl ether from Perstorp).

Turning now to component (g), component (g) is a sulfonate or sulfonic acid having one amino functional group. The colorless radiation curable polyurethane dispersion disclosed herein, which includes component (g), improves the decap performance and print reliability of the inkjet ink including the dispersion, without sacrificing (and in some instances improving) the image quality. Component (g) may be present in an amount of about 2 wt % to about 20 wt % based upon the total wt % of the colorless radiation curable polyurethane. In an example, component (g) may be present in an amount of about 5 wt % to about 15 wt % of the polyurethane binder.

Some examples of component (g) include taurine

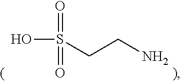

4-Aminotoluene-3-sulfonic acid

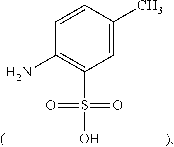

Aniline-2-sulfonic acid

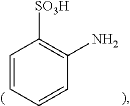 [SMILES: Nc1ccccc1S(=O)(=O)O]

Sulfanilic acid

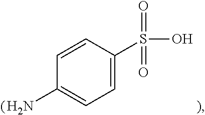 [SMILES: Nc1ccc(S(=O)(=O)O)cc1]

4-Amino-1-naphthalenesulfonic acid

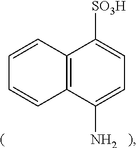 [SMILES: Nc1ccc(S(=O)(=O)O)c2ccccc12]

3-Amino-4-hydroxybenzenesulfonic acid

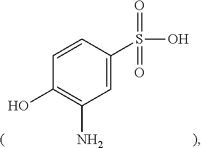 [SMILES: Nc1cc(S(=O)(=O)O)ccc1O]

2-Amino-1-naphthalenesulfonic acid

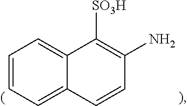 [SMILES: Nc1ccc2ccccc2c1S(=O)(=O)O]

5-Amino-2-methoxybenzenesulfonic acid

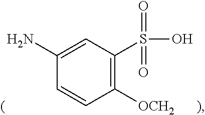

2-(Cyclohexylamino)ethanesulfonic acid

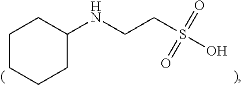 [SMILES: O=S(=O)(O)CCNC1CCCCC1]

and 3-Amino-1-propanesulfonic acid

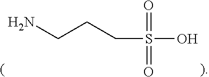

It is to be understood that component (e) has, at most, one hydroxyl functional group in addition to the sulfonate or sulfonic acid.

In an example of the first step of the method for making the colorless radiation curable polyurethane binder dispersion, components (a), in some instances (b), (c), and in some instances (d) are mixed in a reactor with the organic solvent (e.g., methyl ethyl ketone (MEK), tetrahydrofuran (THF), ethyl acetate, acetone, or combinations thereof) and a catalyst (e.g., dibutyl tin dilaurate, bismuth octanoate, and 1,4-diazabicyclo[2.2.2]octane). The reactor may be maintained at a constant temperature and under a dry air mixture. The components may be mixed and the polymerization reaction may be allowed to occur until the % NCO reaches the theoretical value. In an example, the reaction time ranges from about 1 hour to about 4 hours. In another example, the polymerization reaction occurs for about 3 hours at 60° C. to achieve the theoretical value of the % NCO.

In an example of the second step of the method for making the colorless polyurethane polymer, components (e), and in some instances (f) are then added to the polymerization reaction of components (a), in some instances (b), (c), and in some instances (d). Polymerization is continued until the % NCO reaches the theoretical value. In this step, the polymerization reaction may be allowed to occur for a time ranging from about 1 hour to about 4 hours. In an example, the polymerization reaction occurs for 4 hours at 60° C. to achieve the theoretical value of the % NCO.

In an example of the third step of the method for making the polyurethane polymer, component (g) is dissolved in one equivalent of a base and a sufficient amount of deionized water to fully dissolve component (g). Some examples of the base include ammonia, trimethylamine, triethylamine, sodium hydroxide, potassium hydroxide, and lithium hydroxide. The polymer solution made from components (a), in some instances (b), (c), (d), (e), and (f) is cooled to a temperature ranging from about 30° C. to about 50° C. The aqueous solution of component (g) is added to the polymer solution from the second step with vigorous mixing at a temperature ranging from about 30° C. to about 50° C. for at least 30 minutes.

In an example of the fourth step of the method for making the colorless polyurethane polymer, the polyurethane solution may be added to water including a base slowly with vigorous agitation or vice versa. The mixture may be stirred and organic solvent may be removed by distillation to form the colorless polyurethane binder dispersion. In an example, the acid number of the colorless polyurethane binder dispersion ranges from about 10 mg KOH/g solid resin to about 50 mg KOH/g solid resin, or from about 15 mg KOH/g solid resin to less than 45 mg KOH/g solid resin.

Once the colorless radiation curable polyurethane binder dispersion is prepared, the radius of the colorless radiation curable polyurethane binder in the dispersion ranges from about 10 nm to about 200 nm. In an example, the radius of the radiation curable polyurethane binder ranges from about 10 nm to about 100 nm. The double bond density the radiation curable polyurethane binder ranges from about 1.0 meq/g to about 6.0 meq/g. In an example, the double bond density ranges from greater than 3.0 meq/g to about 5.5 meq/g.

As mentioned above, the colorless radiation curable polyurethane binder dispersion may be added with the colorant (e.g., colorant dispersion) and the components of the ink vehicle to form the inkjet ink. After the ink is prepared, the ink(s) may be applied to a medium using any inkjet printer (e.g., thermal, piezoelectric, etc.). In this example, the ink(s) may be applied to a coated offset medium. A coated offset medium is any paper coated to impart better image quality by providing some degree of surface gloss, smoothness, and reduced ink absorbency. Examples of commercially available coated offset media include STERLING® Ultra Gloss (NewPage Corp.) and UTOPIA® (Appleton Coated LLC). In other examples, the medium may be coated or uncoated paper. The medium may also be a vinyl or plastic material.

The ink may then be exposed to curing. Any suitable source of UV radiation may be used to initiate curing, such as, for example, UV lamps, LED (light emitting diode) lamps, LEP (light emitting plasma) plasma torches, or lasers operating in the UV range. Electron beam curing may also be used. The actual wavelength (within the UV range of 280 nm to 400 nm) and intensity of the ultraviolet radiation used may vary, depending at least in part, upon the curable polymer components (e.g., the polyurethane binder) included in the ink. Once the ink is cured, a film forms on the medium.

The radiation curable inkjet ink may be paired with a pre-treatment fixing fluid in an inkjet ink set. In some instances, a pre-treatment fixing fluid may be applied to the medium prior to printing the inkjet ink onto the medium. The pre-treatment fixing fluid is described in greater detail below.

The pre-treatment fixing fluid may be suitable for wet-on-wet printing on the coated offset media. The pre-treatment fixing fluid includes a particular combination of salts (at a desirably low content), a particular co-solvent, and a low HLB (hydrophilic-lipophilic balance) surfactant that is capable of dynamically lowering the surface tension of the pre-treatment fluid. In the examples disclosed herein, the HLB is less than 10. The selected salt(s), solvent, and surfactant together may advantageously promote dot gain and reduce feathering and pigment flotation, resulting in higher quality text prints. The composition of the pre-treatment fixing fluid disclosed herein also exhibits desirable pen reliability.

As mentioned above, the pre-treatment fixing fluid disclosed herein includes calcium propionate, calcium pantothenate, tetraethylene glycol, a low HLB surfactant, an acid, and a balance of water. In some examples, the pre-treatment fixing fluid consists of these components alone, and in other examples, the pre-treatment fixing fluid includes these components and an anti-microbial agent.

The combination of calcium propionate and calcium pantothenate provides the pre-treatment fixing fluid with metal salts that may flocculate the pigment or colorant in the ink deposited thereon, and that may control pigment migration/flotation etc. The calcium propionate may be present in an amount ranging from greater than 4.5 wt % to about 8.0 wt % based on the total wt % of the pre-treatment fluid. The calcium pantothenate may be present in an amount ranging from about 2.0 wt % to 15 wt % or less. In an example, the pre-treatment fixing fluid may include about 6.5 wt % of calcium propionate and about 4.8 wt % of calcium pantothenate. The amount of the metal salts is believed to be high enough to achieve the desired fixing effect without deleteriously affecting pen reliability.

The pre-treatment fixing fluid also includes tetraethylene glycol as a co-solvent. The tetraethylene glycol may be present in total in the pre-treatment fixing fluid in a range from about 0.1 wt % to about 30 wt %. The amount used may depend, at least in part, on the jetting architecture used to apply the pre-treatment fixing fluid. In an example, the amount of tetraethylene glycol used is about 12 wt %.

The pre-treatment fixing fluid also includes the low HLB surfactant. This type of surfactant is capable of dynamically controlling, in particular, lowering, the surface tension of the pre-treatment fixing fluid. The low HLB surfactant may provide the pre-treatment fluid, at the time of its application, with a surface tension that is lower than the surface energy of the coated offset medium upon which the pre-treatment fixing fluid is being applied. As such, the contact angle between the pre-treatment fixing fluid and the medium is zero (0), which enables the pre-treatment fixing fluid to spread out across the medium surface in a horizontal direction (with respect to the medium surface), and effectively wet and reduce the surface energy of the offset coated medium.

One example of the low HLB surfactant is a self-emulsifiable wetting agent based on acetylenic diol chemistry (e.g., SURFYNOL® SE-F surfactant from Air Products and Chemicals, Inc.). Another example of the low HLB surfactant is a non-ionic, alkylphenylethoxylate and solvent free surfactant (e.g., CARBOWET® GA-211 surfactant, a.k.a. SURFYNOL® CT-211, from Air Products and Chemicals, Inc.). The low HLB surfactant is present in the pre-treatment fixing fluid in an amount ranging from about 0.01 wt % to about 1.0 wt % based on the total wt % of the pre-treatment fixing fluid. In an example, the amount of the surfactant is about 0.05 wt %. It is believed that the desired surface tension may not be obtainable with other amounts and/or other surfactants.

In some examples, the pre-treatment fixing fluid may also include an antimicrobial agent. Antimicrobial agent(s), such as biocides and fungicides, may be added to inhibit the growth of harmful microorganisms. Example antimicrobial agents may include the NUOSEPT® (Ashland Inc.), UCARCIDE® or KORDEK® (Dow Chemical Co.), and PROXEL® (Arch Chemicals) series, and combinations thereof. A total amount of the antimicrobial agents in the pre-treatment fixing fluid may range from about 0.05 wt % to about 1 wt %. In an example, the pre-treatment fixing fluid includes about 0.1 wt % of a biocide.

The balance of the pre-treatment fixing fluid is water. In addition, buffer(s) may be used to adjust the pH of the pre-treatment fixing fluid to a particular pH. One example of a suitable buffer is methanesulfonic acid. In some examples, the buffer may be used in an amount sufficient to buffer the pH of the pre-treatment fixing fluid so that it ranges from 4.0 to 7.0. In an example, the pH of the pre-treatment fixing fluid is adjusted to about 6.6 using methanesulfonic acid.

As described above, the surface tension of the pre-treatment fixing fluid is lower than the surface energy of the offset coated medium so that when the pre-treatment fixing fluid is applied on the surface of the offset coated medium, the contact angle between the pre-treatment fixing fluid and the offset coated medium is 0. In an example, the surface tension of the pre-treatment fixing fluid is below 37 dyne/cm. In another example, the surface tension of the pre-treatment fixing fluid ranges from about 30 dyne/cm to about 33 dyne/cm. In still another example, the surface energy of the coated offset medium ranges from about 34 dyne/cm to about 42 dyne/cm, and the surface tension of the pre-treatment fixing fluid is about 33 dyne/cm or lower.

The pre-treatment fixing fluid may be applied onto the medium using any suitable high speed (e.g., from about 50 fpm to about 1000 fpm) inkjet printing apparatus, including thermal inkjet printers or web presses, piezoelectric inkjet printers or web presses, continuous inkjet printers or web presses.

In an example, the amount of pre-treatment fixing fluid that is applied to the medium ranges from about 1 gsm to about 7 gsm.

In the examples disclosed herein, no drying operation is performed after the pre-treatment fixing fluid is applied on the medium. Rather, while the pre-treatment fixing fluid is wet, the inkjet ink disclosed herein is deposited on the pre-treatment fixing fluid on the medium. When multiple ink colors are used, it is to be understood that all of the inks are applied while previously deposited layers are still wet. The ink(s) is also formulated to be deposited by the inkjet printing system.

The salts present in the pre-treatment fixing fluid instantaneously react with the colorant present in the ink, causing the pigment to crash out of ink and fixing the pigment on the medium surface. In addition, the applied pre-treatment fixing fluid provides the coated offset medium with a reduced surface energy, which causes the deposited ink(s) to spread less than if the surface energy were higher. This contributes to bleed control and dot gain, and thus enhances the print quality attributes. This benefit is in addition to the benefits obtained from the instantaneous fixing of the colorant(s) in the ink by the salts in the pre-treatment fixing fluid.

To further illustrate the present disclosure, examples are given herein. It is to be understood that these examples are provided for illustrative purposes and are not to be construed as limiting the scope of the present disclosure.

### EXAMPLES

### Example 1

Several examples of the colorless radiation curable polyurethane binder dispersion disclosed herein and several comparative polyurethane dispersion examples were prepared. The compositions are shown in Table 1, with the wt % of each component that was used. Several properties of the resulting polyurethane binder dispersions are also provided in Table 1.

One of the example radiation curable polyurethane binders, referred to herein as PUD-520, was synthesized as follows:

(Part 1) 48.84 g of BGDA, 0.48 g of monomethyl ether of Hydroquinone (MEHQ), 40.69 g of HDI and 38 g of acetone were mixed in a 500 ml 4-neck round bottom flask. A mechanical stirrer with a glass rod and a TEFLON® blade was attached. A condenser was also attached. The flask was immersed in a constant temperature bath at 70° C. The reactor system was maintained under dry oxygen blanket. 5 drops of dibutyl dilaurate (DBTDL) were added to initiate the polymerization. Polymerization was continued for 2 hours at 70° C. under an air mixture until the %NCO reached the theoretical value.

(Part 2) 42.32g of AHPMA, 0.42g of MEHQ, 8.06g of M-2070 (JEFFAMINE® M-2070 from Huntsman Chemical) and 12 g of acetone were mixed in a beaker and added to the reactor system over 30 seconds. 10 g of acetone was used to rinse off the residual monomers on the beaker and was added to the reactor system. The polymerization was continued for four more hours at 60° C. until the % NCO reached the theoretical value.

(Part 3) The water bath temperature was reduced to 50° C. for 15 minutes. 10.09 g of taurine, 8.16 g of triethanolamine (TEA), and 50.45 g of deionized water were mixed in a beaker until the taurine was dissolved.

(Part 4) The taurine solution was added to the prepolymer solution at 50° C. with vigorous stirring for over 3 minutes. The solution became viscous and slightly hazy. The solution was stirred for an additional 30 minutes at 50° C. The solution became clear after about 10 minutes.

This prepolymer solution was added to 281 g of cold deionized water over 10 minutes with enough agitation to form a polyurethane dispersion (PUD). The agitation was continued for 30 minutes at room temperature.

The PUD was then aged for 30 minutes at 55° C. in a water bath. The PUD was filtered through 400 mesh stainless sieve. Acetone was removed with a Rotovap at 55° C. The final PUD was filtered through fiber glass filter paper.

The average radius of the polyurethane in PUD-520 was measured by Malvern Zetasizer and was 38 nm. The pH was 8.1. The %solid was 32.3%.

Each of the other example and comparative example colorless polyurethane dispersions were prepared in a similar manner to PUD-520, using the components and weight percentages set forth in Table 1.

The following abbreviations are used in Table 1: AN (acid number), DB (double bond density, meq/g), HDI (Hexamethylene-1,6-diisocyanate), PTMG (Poly(tetramethylene glycol), M_{w} of 1000), PTMG2K (Poly(tetramethylene glycol), M_{w} of 2000), PPG2K (Poly(propylene glycol), M_{w} of 2000), C-2090 (Carbonate polyol [(3-methyl-1,5-pentanediol) MPD/1,6-(1,6-hexanediol)HD=9/1] made by Kuraray), P-2010 (3-methyl-1,5-pentanediol (MPD adipate) made by Kuraray), BGDA (Bisphenol A diglycidylether), DMPA (2,2′-Dimethylol Propionic Acid), PETA (Pentaerythritoltriacrylate), AHPMA (3-(acryloxy)-2-hydroxypropyl methacrylate), M-2070 (JEFFAMINE® M-2070 from Huntsman Chemical), and MPEO-750 (Poly(ethylene glycol) methyl ether) available from Sigma-Aldrich).

TABLE 1

| Component | | | | | | | | | | (f) | | |
|---|---|---|---|---|---|---|---|---|---|---|---|---|
| PUD- | | | (a) | | (b) | (c) | (d) | (e) | | M- | MPEO- | (g) |
| ID | AN | DB | HDI | IPDI | Polyol | BGDA | DMPA | PETA | AHPMA | 2070 | 750 | Taurine |
| 442-1* | 16.9 | 4.7 | 27.6 | None | 10.9 | 9.94 | 4.0 | None | 45.4 | None | None | None |
| | | | | | (PTMG) | | | | | | | |
| 490* | 16.9 | 4.7 | 27.6 | None | 10.9 | 9.94 | 4.0 | None | 45.4 | None | None | None |
| | | | | | (PPG2K) | | | | | | | |
| 491* | 16.9 | 4.7 | 27.6 | None | 10.9 | 9.9 | 4.0 | None | 45.4 | None | None | None |
| | | | | | (C-2090) | | | | | | | |
| 492* | 16.9 | 4.7 | 27.6 | None | 10.9 | 9.9 | 4.0 | None | 45.4 | None | None | None |
| | | | | | (P-2010) | | | | | | | |
| 480* | 17.6 | 5.1 | 28.5 | None | None | 17.9 | 3.1 | 32.1 | None | 2.77 | None | None |
| 479* | 17.3 | 4.9 | 27.7 | None | None | 17.5 | 3.0 | 31.3 | None | 5.2 | None | None |
| 479-2* | 17.3 | 4.9 | 27.7 | None | None | 17.5 | 3.0 | 31.3 | None | 5.2 | None | None |
| 485* | 16.2 | 4.5 | 26.5 | None | 10.9 | 10.8 | 3.9 | None | 43 | 5.25 | None | None |
| | | | | | (PTMG2K) | | | | | | | |
| 538 A* | 16.1 | 4.4 | 25.3 | None | None | 15.9 | 2.7 | 27.6 | None | 15 | None | None |
| 513* | 16.7 | 5.3 | 24.5 | None | None | 15.1 | 4.0 | 46.4 | None | 10 | None | None |
| 465* | 16.2 | 5.2 | 23.8 | None | None | 14.6 | 3.9 | 46.1 | None | 11.6 | None | None |
| 542* | 16.2 | 5.2 | 23.8 | None | None | 14.6 | 3.9 | 46.1 | None | 11.6 | None | 1.5 |
| 544* | 20.3 | 5.2 | 24.3 | None | None | 11.8 | 4.9 | 47.1 | None | 11.6 | None | None |
| 516 | 22.5 | 4.5 | 27 | None | None | 25.9 | None | None | 36.7 | 5.3 | None | 5 |
| 517 | 30.4 | 4.3 | 27.3 | None | None | 26.2 | None | None | 34.2 | 5.4 | None | 6.8 |
| 520 | 30.2 | 4 | 27.1 | None | None | 32.5 | None | None | 28.2 | 5.4 | None | 6.7 |
| 518 | 40.9 | 4 | 27.8 | None | None | 26.7 | None | None | 30.9 | 5.5 | None | 9.1 |
| 519 | 49.1 | 4.1 | 29.5 | None | None | 28.3 | None | None | 31.3 | None | None | 11 |
| 549 | 30.5 | 3.9 | 27.4 | None | None | 32.9 | None | None | 27.7 | None | 5 | 6.8 |
| 620 | 44.9 | 3.7 | None | 35.5 | None | 25.8 | None | None | 28.6 | None | None | 10 |

*Comparative Colorless Radiation Curable Polyurethane Binder

### Example 2

In this example, example and comparative ink compositions were prepared with a cyan pigment (present in a dispersion with water) and the example and comparative colorless radiation curable polyurethane binder dispersions listed in Table 1 of Example 1. The general formulation of each of the example and comparative ink compositions is shown in Table 2. However, it is to be understood that each ink included a different one of the colorless radiation curable polyurethane binder dispersions listed in Table 1. The example and comparative inks were prepared by adding the respective colorless radiation curable binder dispersion and the cyan pigment dispersion to the remaining ink components shown in Table 2.

TABLE 2

| | | wt % |
|---|---|---|
| Ingredient | Specific component | active |
| PUD | Colorless Radiation curable | 5.00 |
| | polyurethane binder dispersion of | |
| | TABLE 1 | |
| Co-solvent | 1-(2-hydroxyethyl)-2-pyrrolidone | 10.00 |
| Anti-Kogation agent | CRODAFOS ® N3A | 0.75 |
| Surfactant | SURYNOL ®-SE-F (80%) | 0.40 |
| Surfactant | TEGO ® WET 510 | 0.40 |
| Additive | LEG-1 | 1.00 |
| Photoinitiator | IRGACURE ® 2959 | 0.50 |
| Colorant | Cyan pigment | 2.50 |
| Water | | Balance |

A pre-treatment fixer fluid was also prepared. The composition of the pre-treatment fixing fluid is shown below in Table 3.

TABLE 3

| Compositional Components | wt % |
|---|---|
| Calcium Propionate | 6.5 |
| Calcium Pantothenate | 4.8 |
| Tetraethylene Glycol | 12 |
| SURFYNOL ® SE-F | 0.05 |
| Biocide | 0.2 |
| Methanesulfonic acid | Used to |
| | Adjust pH to |
| | 6.6 |
| Water | Balance |

After each example and comparative ink composition was prepared, the decap was tested for each ink composition. Decap testing was performed on a testbed that included print cartridge electronics to print thermal inkjet pens with a nominal drop weight of 6 ng. These pens were printed on a standard office paper media loaded on a rotating drum (30 inches per second) with a pen frequency of 12 KHz and pen temp of 55° C. Pens were printed at discreet and increasing time intervals of up to 10 seconds. Between each print time interval, the pen was kept idle and uncapped. Decap at 1 second is reported as # of spits (drops) required to attain a healthy (drop wt and location) normal drop on the medium. The results are shown below in Table 4.

In addition, optical density and 75° gloss were tested. For optical density and 75° gloss measurements, the pre-treatment fixing fluid was printed onto STERLING® Ultra Gloss (NewPage Corp.) media in an amount of about 2.5 gsm (g/m²). Each example and comparative ink composition was then printed onto the media containing the pre-treatment fixing fluid in an amount of about 10 gsm. The prints were dried and exposed to UV light.

Optical density (OD) and 75° gloss measurements were taken of the printed images. The optical density (OD) measurements were taken using an X-rite eXact™ densitometer and 75° gloss measurements were taken using a BYK-Gardner MICRO-GLOSS® 75° Meter (BYK-Gardner USA). The results of the optical density (OD) and 75° gloss measurements are shown below in Table 4.

Table 4 also lists each of the inks and the polyurethane dispersion within that ink.

TABLE 4

| | | | | # spits to |
|---|---|---|---|---|
| | | | | recover nozzle |
| Ink ID | PUD-ID | OD | 75° gloss | health |
| Comparative | 442-1* | 1.30 | 61.2 | 10 |
| Ink 1 | | | | |
| Comparative | 490* | 1.27 | 53.5 | 8 |
| Ink 2 | | | | |
| Comparative | 491* | 1.22 | 55.9 | 8 |
| Ink 3 | | | | |
| Comparative | 492* | 1.32 | 58.9 | 8 |
| Ink 4 | | | | |
| Comparative | 480* | 1.26 | 58.7 | 8 |
| Ink 5 | | | | |
| Comparative | 479* | 1.28 | 57.7 | 7 |
| Ink 6 | | | | |
| Comparative | 479-2* | 1.23 | 57.3 | 11 |
| Ink 7 | | | | |
| Comparative | 485* | 1.23 | 57.6 | 8 |
| Ink 8 | | | | |
| Comparative | 538 A* | 1.37 | 65.9 | 6 |
| Ink 9 | | | | |
| Comparative | 513* | 1.56 | 64.3 | 21 |
| Ink 10 | | | | |
| Comparative | 465* | 1.69 | 65.3 | 33 |
| Ink 11 | | | | |
| Comparative | 542* | 1.83 | 75.8 | 29 |
| Ink 12 | | | | |
| Comparative | 544* | 1.71 | 73.4 | 27 |
| Ink 13 | | | | |
| Ink 1 | 516 | 1.54 | 64.6 | 11 |
| Ink 2 | 517 | 1.54 | 64.8 | 10 |
| Ink 3 | 520 | 1.55 | 63.8 | 11 |
| Ink 4 | 518 | 1.55 | 67.3 | 10 |
| Ink 5 | 519 | 1.59 | 69.4 | 10 |
| Ink 6 | 549 | 1.58 | 70.9 | 10 |
| Ink 7 | 620 | 1.49 | 73 | 10 |

*Comparative Colorless Radiation Curable Polyurethane Binder

As shown in Table 4, the comparative example ink compositions (comparative inks 1-13) have a reduced optical density and 75° gloss measurement of the printed image or an increased number of spits to recover the nozzle health when compared to the example ink compositions. However, none of the comparative example ink compositions have an optical density of at least 1.49, a 75° gloss of at least 63.8, and 11 or less spits required to recover the nozzle health. Rather, the comparative inks (i.e., 10-13) that exhibit a higher optical density and 75° gloss also exhibit worse decap performance. Similarly, teh comparative inks (i.e., 1-9) that exhibit suitable decap performance exhibit worse optical density and/or 75° gloss. The example ink compositions (inks 1-7) had both an optical density of at least 1.49 or more, a 75° gloss of at least 63.8, and 11 or less spits required to recover the nozzle health.

In general, during printing idle time, water evaporation from ink at the print head opening leads to significant viscosity increase close to the print head nozzles, which can form a viscous plug that prevents or interferes with the jetting of subsequent ink drops. The colorless radiation curable polyurethane binder disclosed herein (including, in particular, component g) contributes to the ink having a lower viscosity build up. As such, the ink is prevented from becoming too viscous near the nozzles between the uncapped time intervals, thereby preventing clogging of the pen opening. As such, decap is improved and the print cartridge requires fewer drops to attain a normal, accurate drop on the medium.

Furthermore, when included with the component g, component f (i.e., the additional homopolymer or copolymer of poly(ethylene glycol) having one hydroxyl functional group or one amino functional group) may further improve the image quality of the print that is formed. Component (f) may be interacting with the pre-treatment fixing fluid component(s) in a manner that significantly refines the image quality. As such, the improved decap performance and print quality of the example ink compositions may be due, at least in part, to the incorporation of components f and g.

It is to be understood that the ranges provided herein include the stated range and any value or sub-range within the stated range. For example, a range from about 5 wt % to about 15 wt % should be interpreted to include not only the explicitly recited limits of about 5 wt % to about 15 wt %, but also to include individual values, such as 6.5 wt %, 10 wt %, 12.5 wt %, 14 wt %, etc., and sub-ranges, such as from about 7 wt % to about 12 wt %, from about 5 wt % to about 10 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A colorless radiation curable binder dispersion, the radiation curable binder dispersion comprising:
water; and
a radiation curable polyurethane dispersed in the water, the radiation curable polyurethane having been formed from:
a polyisocyanate;
an acrylate or methacrylate, the acrylate or methacrylate having at least two hydroxyl functional groups and an acrylate or methacrylate functional group;
an other acrylate or methacrylate, the other acrylate or methacrylate having a hydroxyl functional group or an amino functional group; and one of
i) a sulfonate or sulfonic acid having one amino functional group;
ii) a combination of i and a compound including a carboxylic functional group and a hydroxyl functional group or an amino functional group;
iii) a combination of i and a homopolymer or copolymer of poly(ethylene glycol) having one or two hydroxyl functional groups or one or two amino functional groups at one end of its chain; or
iv) a combination of i, a compound including a carboxylic functional group and a hydroxyl functional group or an amino functional group, and a homopolymer or copolymer of poly(ethylene glycol) having one or two hydroxyl functional groups or one or two amino functional groups at one end of its chain.

2. The colorless radiation curable binder dispersion as defined in claim 1, wherein the radiation curable polyurethane excludes a reactive colorant.

3. The colorless radiation curable binder dispersion as defined in claim 1 wherein the sulfonate or sulfonic acid is selected from the group consisting of taurine, 4-Aminotoluene-3-sulfonic acid, Aniline-2-sulfonic acid, Sulfanilic acid, 4-Amino-1-naphthalenesulfonic acid, 3-Amino-4-hydroxybenzenesulfonic acid, 2-Amino-1-naphthalenesulfonic acid, 5-Amino-2-methoxybenzenesulfonic acid, 2-(Cyclohexylamino)ethanesulfonic acid, and 3-Amino-1-propanesulfonic acid.

4. The colorless radiation curable binder dispersion as defined in claim 1 wherein the radiation curable binder is formed with iii or iv, and wherein the homopolymer or copolymer of poly(ethylene glycol) has a water solubility greater than 30% v/v.

5. The colorless radiation curable binder dispersion as defined in claim 4 wherein the homopolymer or copolymer of poly(ethylene glycol) is one of:
a poly(ethylene glycol) copolymer selected from the group consisting of a copolymer of poly(ethylene) and poly(ethylene glycol) with the one hydroxyl functional group, a copolymer of poly(propylene glycol) and poly(ethylene glycol) with the one hydroxyl functional group, and a copolymer of poly(ethylene glycol) and poly(propylene glycol) with the one amino functional group; or
a poly(ethylene glycol) homopolymer selected from the group consisting of monoamine terminated poly(ethylene glycol), poly(ethylene glycol) monomethyl ether, poly(ethylene glycol) monoethyl ether, poly(ethylene glycol) monopropyl ether, poly(ethylene glycol) monobutyl ether, and two hydroxyl terminated at one end poly(ethylene glycol).

6. The colorless radiation curable binder dispersion as defined in claim 1 wherein:
the polyisocyanate is present in an amount ranging from about 20 wt % to about 50 wt % based on a total wt % of the radiation curable polyurethane;
the acrylate or methacrylate having the at least two hydroxyl functional groups and having the acrylate functional group or the methacrylate functional group is present in an amount ranging from 10 wt % to about 40 wt % based on the total wt % of the radiation curable polyurethane;
the other acrylate or methacrylate having the hydroxyl functional group or the amino functional group is present in an amount ranging from about 10 wt % to about 60 wt % based on the total wt % of the radiation curable polyurethane;
the sulfonate or sulfonic acid having the one amino functional group is present in an amount ranging from greater than 2 wt % to about 20 wt % based on the total wt % of the radiation curable polyurethane; and when included:
the compound including the carboxylic functional group and the hydroxyl functional group or the amino functional group is present in an amount ranging from greater than 0 wt % to about 10 wt % based on the total wt % of the radiation curable polyurethane; and
the homopolymer or copolymer of poly(ethylene glycol) is present in an amount ranging from greater than 0 wt % to about 15 wt % based on the total wt % of the radiation curable polyurethane.

7. The colorless radiation curable binder dispersion as defined in claim 6 wherein the radiation curable polyurethane is further formed from a polyol having at least two hydroxyl functional groups, wherein the polyol is present in an amount ranging from about 10 wt % to about 30 wt % based on the total wt % of the radiation curable polyurethane.

8. The colorless radiation curable binder dispersion as defined in claim 1 wherein the radiation curable polyurethane has a double bond density ranging from about 1 to about 6, and an acid number ranging from about 10 mg/g and about 50 mg/g.

9. The colorless radiation curable binder dispersion as defined in claim 1 wherein the radiation curable polyurethane is further formed from a polyol having at least two hydroxyl functional groups.

10. A radiation curable inkjet ink, comprising:
water;
a colorant;
a co-solvent;
a photoinitiator; and
a colorless radiation curable polyurethane binder, the colorless radiation curable polyurethane binder having been formed from:
a polyisocyanate;
an acrylate or methacrylate, the acrylate or methacrylate having at least two hydroxyl functional groups and an acrylate or methacrylate functional group;
an other acrylate or methacrylate, the other acrylate or methacrylate having a hydroxyl functional group or an amino functional group; and one of
i) a sulfonate or sulfonic acid having one amino functional group;
ii) a combination of i and a compound including a carboxylic functional group and a hydroxyl functional group or an amino functional group;
iii) a combination of i and a homopolymer or copolymer of poly(ethylene glycol) having one or two hydroxyl functional groups or one or two amino functional groups at one end of its chain; or
iv) a combination of i, a compound including a carboxylic functional group and a hydroxyl functional group or an amino functional group, and a homopolymer or copolymer of poly(ethylene glycol) having one or two hydroxyl functional groups or one or two amino functional groups at one end of its chain.

11. The radiation curable inkjet ink as defined in claim 10 wherein the radiation curable binder is formed from iii or iv, and wherein the homopolymer or copolymer of poly(ethylene glycol) has a water solubility greater than 30% v/v.

12. The radiation curable inkjet ink as defined in claim 10, further comprising a polymeric dispersant to disperse the colorant.

13. The radiation curable inkjet ink as defined in claim 10 wherein the sulfonate or sulfonic acid is selected from the group consisting of taurine, 4-Aminotoluene-3-sulfonic acid, Aniline-2-sulfonic acid, Sulfanilic acid, 4-Amino-1-naphthalenesulfonic acid, 3-Amino-4-hydroxybenzenesulfonic acid, 2-Amino-1-naphthalenesulfonic acid, 5-Amino-2-methoxybenzenesulfonic acid, 2-(Cyclohexylamino)ethanesulfonic acid, and 3-Amino-1-propanesulfonic acid.

14. The radiation curable inkjet ink as defined in claim 10, further comprising a surfactant and an anti-kogation agent.

15. An inkjet ink set, comprising:
a pre-treatment fixing fluid, including:
calcium propionate present in an amount ranging from greater than 4.5 to about 8.0 wt % based on a total wt % of the pre-treatment fixing fluid;
calcium pantothenate present in an amount ranging from about 2.0 wt % to equal to or less than 15 wt % based on the total wt % of the pre-treatment fixing fluid;
tetraethylene glycol;
a surfactant;
an acid present in an amount sufficient to render a pH of the pre-treatment fixing fluid from about 4.0 to about 7.0; and
a balance of water; and
a radiation curable inkjet ink, including:
water;
a colorant;
a co-solvent;
a photoinitiator; and
a radiation curable polyurethane binder, the radiation curable polyurethane binder having been formed from:
a polyisocyanate;
an acrylate or methacrylate, the acrylate or methacrylate having at least two hydroxyl functional groups and an acrylate or methacrylate functional group;
an other acrylate or methacrylate, the other acrylate or methacrylate having a hydroxyl functional group or an amino functional group; and one of
i) a sulfonate or sulfonic acid having one amino functional group;
ii) a combination of i and a compound including a carboxylic functional group and a hydroxyl functional group or an amino functional group;
iii) a combination of i and a homopolymer or copolymer of poly(ethylene glycol) having one or two hydroxyl functional groups or one or two amino functional groups at one end of its chain; or
iv) a combination of i, a compound including a carboxylic functional group and a hydroxyl functional group or an amino functional group, and a homopolymer or copolymer of poly(ethylene glycol) having one or two hydroxyl functional groups or one or two amino functional groups at one end of its chain.
